(19) United States
(12) Patent Application Publication
(10) Pub. No.: US 2001/0009126 A1
(43) Pub. Date: Jul. 26, 2001

(54) VACUUM DEAERATION DEVICE

(76) Inventor: AKIHIKO NAGAI, KAWAGUCHI-SHI (JP)

Correspondence Address: DARBY & DARBY PC, 805 THIRD AVENUE, NEW YORK, NY, 10022

(21) Appl. No.: 09/303,980

(22) Filed: May 3, 1999

(30) Foreign Application Priority Data
Oct. 9, 1998 (JP) HEI 10-287471

(51) Int. Cl. B01D 19/00

(52) U.S. Cl. 96/6; 95/46

(57) ABSTRACT

This invention's object is to eliminate a possibility that both aromatic substances and olefin substances are resolved into deaerated liquid contacted with a transmission film. As a transmission film for allowing only gas to pass and preventing liquid from being passed therethrough, there is applied a product of high volatile characteristic in which dispersion liquid composed of single solution not containing both aromatic substances and olefin substances is added to particle plastic substrate to form paste material is extruded and baked.

### FIELD OF THE INVENTION AND RELATED ART STATEMENT

This invention relates to a vacuum deaeration device in which a transmission film for allowing only gas to pass therethrough and preventing liquid from being transmitted is mounted within a vacuum container, a pressure within the vacuum container is reduced by a vacuum pump or the like to deaerate resolved gas from liquid (deaerated liquid) contacted with the aforesaid transmission film through the transmission film, and more particularly a vacuum deaeration device suitable for removing resolved gas from liquid (deaerated liquid) in various kinds of production process facilities including a liquid chromatograph as well as various kinds of physical and chemical and analytical devices, pharmaceutical engineering, semi-conductors and liquid crystals and the like.

In the case that analytical processing is carried out by an analytical equipment such as a liquid chromatograph device or the like, for example, resolved gas is removed (deaerated) from sample liquid or solvent, dampening liquid or the like in view of improving reliability in measurement data, although a fluorine transmission film for allowing only gas to pass therethrough and preventing liquid from being transmitted is used at a location of the deaeration device applied for this operation contacted with the aforesaid sample liquid or solvent, dampening liquid or the like.

The transmission film used in this type of deaeration device is usually manufactured by a method wherein residual gasoline substances (naphtha, white oil or the like) are added to and mixed with powder-like fluorine plastic substrate to form paste, the paste material is extruded and baked under a high temperature (approximately 100° C. to 400° C.).

At this time, liquid of low boiling point such as the aforesaid gasoline residuals is evaporated during baking operation and removed. However, actually, liquid of low boiling point, in particular, aromatic substances and olefin substances are not completely evaporated and a small amount of substances is left in the transmission film. These substances remained in the transmission film are freely separated when liquid (deaerated liquid) is contacted with the transmission film, resolved into deaerated liquid, and a bad influence (a measurement error or the like) is applied to the result of measurement performed by the liquid chromatograph device or quality keeping controls in various kinds of production processes.

### OBJECT AND SUMMARY OF THE INVENTION

This invention has been completed in view of such disadvantages as above in the prior art, wherein the present invention provides a vacuum deaeration device having no possibility that aromatic substances or olefin substances applying bad influence against the result of measurement performed by an analytical equipment or the like and quality keeping controls at various kinds of production processes are resolved into liquid (deaerated liquid) contacted with the transmission film.

The vacuum deaeration device of the present invention accomplishing the aforesaid object is a vacuum deaeration device in which a transmission film for allowing only gas to pass therethrough and preventing liquid from being transmitted is mounted within a vacuum container, a pressure within said vacuum container is reduced to cause resolved gas to be deaerated from the deaerated liquid through said transmission film characterized in that as a transmission film, there is applied a product of high volatile characteristic in which dispersion liquid composed of single solution not containing both aromatic substances and olefin substances is added to particle plastic substrate to form paste material is extruded and baked.

In one preferred embodiment of the present invention, as the aforesaid dispersion liquid, there is applied single solution of linear chain-like parafin substances not containing unsaturated hydrocarbon or having a volatile characteristic and not containing aromatic substances and olefin substances, and as the aforesaid plastic substrate, polytetrafluoroethylene (PTFE) is used.

### BRIEF DESCRIPTION OF THE DRAWINGS

FIG. 1 is a schematic diagram for showing one example of the preferred embodiment of the present invention.

FIG. 2 is a chromatogram detected by a gradient resolved liquid chromatography.

### DETAILED DESCRIPTION OF PREFERRED EMBODIMENTS

Then, one preferred embodiment of the present invention will be described in detail as follows.

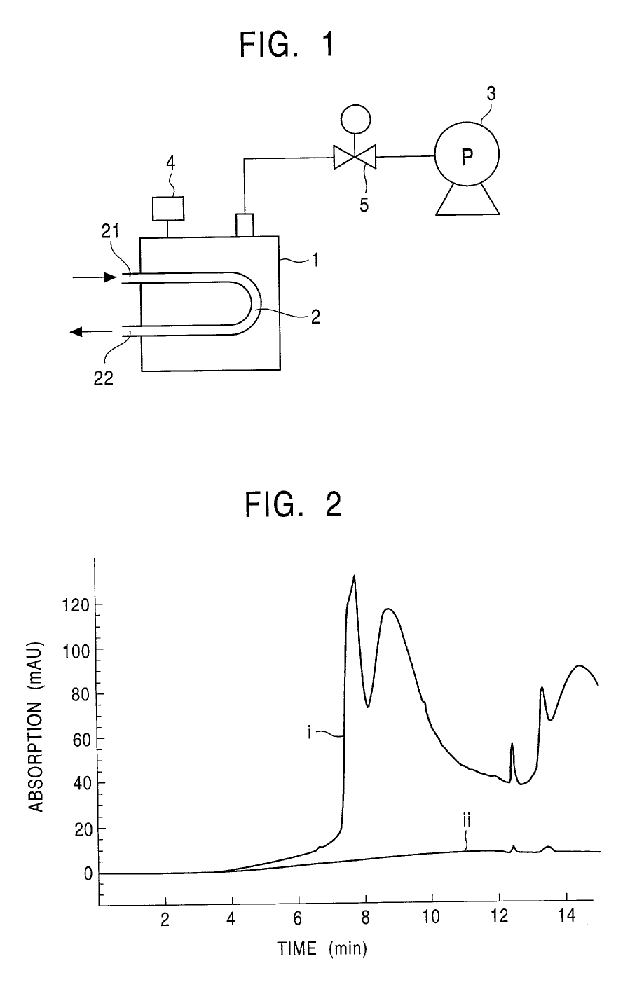

In FIG. 1, reference numeral 1 denotes a vacuum container, reference numeral 2 denotes a tube-like transmission film mounted within the vacuum container 1 so as to pass only gas and prevent transmission of liquid, and reference numeral 3 denotes a vacuum pump for reducing pressure inside the vacuum container 1.

In the case of the preferred embodiment shown in the drawing, it is constructed such that the transmission film 2 formed into a tube with a predetermined length is used, one or a plurality of films are mounted within the vacuum container and at the same time each of a liquid inlet 21 and a liquid outlet 22 of the tube-like transmission film 2 is placed outside the vacuum container 1, the deaerated liquid is flowed from the liquid inlet 21 of the tube-like transmission film 2 while a pressure of the inside part of the vacuum container 1 is being controlled to be reduced by a vacuum pump 3 and then resolved liquid is deaerated from the deaerated liquid while the liquid is discharged out of the outlet 22.

In addition, reference numeral 4 in the drawing denotes a pressure sensor, reference numeral 5 denotes a check valve operated with a specified pressure, respectively, and it is not necessarily required to arrange these devices, and if the pressure sensor 4 or check valve 5 is mounted, a pressure within the vacuum container 1 can be controlled in a more precise and positive manner.

The transmission film 2 of the present invention is manufactured by a method wherein dispersion liquid is added to and mixed with particle-like plastic substrate to form paste, the pasted plastic substrate is extruded by an extruder into a tube-like shape or a film-like shape or a membrane-like shape, baked under a high temperature (approximately 100° C. to 400° C.) and then the transmission film is mounted within the vacuum container 1 in such a way that it may be contacted with the deaerated liquid.

In the present specification, it is assumed that the expression of “particle” includes a state of fine particle.

As plastic substrate which can be applied for manufacturing the transmission film 2 of the present invention, although plastic substrate of fluorine system for allowing only gas to pass and preventing transmission of liquid, more practically polymer containing fluorine such as polytetrafluoroethylene (PTFE) or fluoric ethylene propylene (FEP), ethylene tetrafluoroethylene (ETFE) or the like can be applied, the present invention is not limited to these polymers.

In addition, as dispersion liquid added to and mixed with particle plastic substrate, single solution of high volatile characteristic not containing aromatic substances and olefin substances is used. More practically, single solution of high volatile characteristic not containing aromatic substances and olefin substances such as linear chain-like parafin substances not containing non-saturated hydrocarbon is used as dispersion liquid.

### EXAMPLE

As plastic substrate, polytetrafluoroethylene (hereinafter abbreviated as PTFE) was used, linear chain-like parafin substances not containing non-saturated hydrocarbon was used as dispersion liquid, the aforesaid dispersion liquid was added to and mixed with particle PTFE and then paste-like PTFE was made. This paste-like PTFE was extruded into a tube-form by an extruder and baked to attain a tube-like transmission film.

The aforesaid tube-like transmission film made of PTFE was assembled into a vacuum deaeration device for use in removing (deaerating) gas in advance from sample liquid or solvent, dampening liquid or the like at a liquid chromatograph device and then detected by a gradient solution liquid chromatography. In the case of gradient solution liquid chromatography, a concentration of moving phase (solvent) is changed continuously during chromatograph operation, contaminated substances separated in the moving phase are condensed in the gradient solution in the separating column and solved with a rate of corresponding solution agent in the gradient. Accordingly, when aromatic substances having a power of absorbing ultra-violet rays enters into a sensor (ultraviolet ray absorption sensor), for example, it may interfere with measurement.

FIG. 2 shows a chromatogram detected by a gradient solution liquid chromatography, wherein i is attained by a liquid chromatograph having PTFE tube-like transmission film of prior art and ii is attained by a liquid chromatograph having PTFE tube-like transmission film manufactured by the aforesaid preferred embodiment. As the sensing operation, mixture of acetonitrile-water was used and as the sensor, an ultra-violet ray absorbing sensor with a wave-length of 210 nm was used.

As apparent from this FIG. 2, it is seen that contamination generating bad influence (error) on a result of measurement in the liquid chromatograph in the case of PTFE tube-like transmission film i of the prior art is produced and a substantial flat base line is indicated in the case of PTFE tube-like transmission film ii of the preferred embodiment of the present invention and a scarce interference is found in a quantitative measurement of sample.

In accordance with the vacuum deaeration device of the present invention, product having dispersion liquid of high volatile characteristic composed of single solution not containing both aromatic substances and olefin substances added to particle plastic substrate to form paste material and the paste material being extruded and baked is used as a transmission film for allowing only gas to pass and preventing liquid from being transmitted, so that the aromatic substances and olefin substances are not originally present at the transmission film contacted with the deaerated liquid, resulting in that there occurs no possibility that both aromatic substances and olefin substances are freely separated and resolved into deaerated liquid when the deaerated liquid is contacted with this transmission film. As a result, there occurs no possibility at all that a bad influence (a measurement error or the like) is applied to a measurement result performed by the liquid chromatograph device or the like or quality keeping control at various kinds of production processes.

Having described specific preferred embodiments of the invention with reference to the accompanying drawings, it will be appreciated that the present invention is not limited to those precise embodiments, and that various changes and modifications can be effected therein by one of ordinary skill in the art without departing from the scope of the invention as defined by the appended claims.

What is claimed is:

1. A vacuum deaeration device in which a transmission film for allowing only gas to pass and preventing liquid from being transmitted is mounted within a vacuum container, pressure within said vacuum container is reduced to cause resolved gas to be deaerated from the deaerated liquid through said transmission film characterized in that as a transmission film, there is applied a product of high volatile characteristic in which dispersion liquid composed of single solution not containing both aromatic substances and olefin substances is added to particle plastic substrate to form paste material is extruded and baked.

2. A vacuum deaeration device according to claim 1 characterized in that said dispersion liquid is linear chain-like parafin substances not containing non-saturated hydrocarbon.

3. A vacuum deaeration device according to claim 1 characterized in that said plastic substrate is polytetrafluoroetylene.
